(19) United States
(12) Patent Application Publication
(10) Pub. No.: US 2019/0132274 A1
(43) Pub. Date: May 2, 2019

(54) TECHNIQUES FOR RANKING POSTS IN COMMUNITY FORUMS

(71) Applicant: Microsoft Technology Licensing, LLC, Redmond, WA (US)

(72) Inventors: Satishkumar SESHIAH, Sammamish, WA (US); Khoa Chau PHAM, Redmond, WA (US); Aleksey SINYAGIN, Redmond, WA (US)

(21) Appl. No.: 15/799,745

(22) Filed: Oct. 31, 2017

(51) Int. Cl. H04L 12/58; G06F 17/30

(52) U.S. Cl. CPC H04L 51/26; H04L 51/34; G06Q 10/107; G06F 17/30634; H04L 51/16; G06F 17/30864

(57) ABSTRACT

Described are examples for classifying responses to a post in a community forum. An initial post in the community forum can be received along with multiple response posts in response to the initial post. For each of the multiple response posts, a feature vector including an array of numbers each indicative of a feature of the corresponding response post can be generated. A weight can be applied to one or more of the array of numbers in the feature vector for each of the multiple response posts. Each of the multiple response posts can be ranked in an order based at least in part on the array of numbers in the feature vector for each of the multiple response posts.

### BACKGROUND

Community forums have developed as vast knowledge-bases to assist in providing solutions to stated issues or questions. Typically, a community forum is provided via a website where users can post messages to the forum for viewing/responding by other users. In some instances, users post questions or issues for which they are seeking resolution, and other users can post response messages that hopefully include an answer or some advice for the user that is relevant to the question or issue. Some community forums include a voting mechanism that allows users to vote for certain response messages as a solution to the question or issue stated in the initial post, and the community forum can display the response messages according to the voting percentage (e.g., rather than chronologically based on post time). Other community forums allow for rating users based on expertise such that response posts from higher rated users are displayed before those of lower rated users.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

In an example, a method for classifying responses to a post in a community forum is provided. The method includes receiving an initial post in the community forum along with multiple response posts in response to the initial post, generating, for each of the multiple response posts, a feature vector comprising an array of numbers each indicative of a feature of the corresponding response post, applying a weight to one or more of the array of numbers in the feature vector for each of the multiple response posts, ranking each of the multiple response posts in an order based at least in part on the array of numbers in the feature vector for each of the multiple response posts, and providing at least a subset of the multiple response posts to a client for displaying based on the order.

In another example, a device for classifying responses to a post in a community forum is provided. The device includes a memory storing one or more parameters or instructions for providing the community forum, at least one processor coupled to the memory. The at least one processor is configured to receive an initial post in the community forum along with multiple response posts in response to the initial post, generate, for each of the multiple response posts, a feature vector comprising an array of numbers each indicative of a feature of the corresponding response post, apply a weight to one or more of the array of numbers in the feature vector for each of the multiple response posts, rank each of the multiple response posts in an order based at least in part on the array of numbers in the feature vector for each of the multiple response posts, and provide at least a subset of the multiple response posts to a client for displaying based on the order.

In another example, a computer-readable medium, including code executable by one or more processors for classifying responses to a post in a community forum is provided. The code includes code for receiving an initial post in the community forum along with multiple response posts in response to the initial post, generating, for each of the multiple response posts, a feature vector comprising an array of numbers each indicative of a feature of the corresponding response post, applying a weight to one or more of the array of numbers in the feature vector for each of the multiple response posts, ranking each of the multiple response posts in an order based at least in part on the array of numbers in the feature vector for each of the multiple response posts, and providing at least a subset of the multiple response posts to a client for displaying based on the order.

To the accomplishment of the foregoing and related ends, the one or more implementations comprise the features hereinafter fully described and particularly pointed out in the claims. The following description and the annexed drawings set forth in detail certain illustrative features of the one or more implementations. These features are indicative, however, of but a few of the various ways in which the principles of various implementations may be employed, and this description is intended to include all such implementations and their equivalents.

### BRIEF DESCRIPTION OF THE DRAWINGS

FIG. 1 is a schematic diagram of an example of a server for providing community forum functionality in accordance with examples described herein.

FIG. 2 is a flow diagram of an example of a method for ranking or classifying response posts in a community forum in accordance with examples described herein.

FIG. 3 is a flow diagram of an example of a method for training a model for ranking or classifying response posts in a community forum in accordance with examples described herein.

FIG. 4 is a flow diagram of an example of a data flow for extracting features of response posts for ranking or classifying response posts in a community forum in accordance with examples described herein.

FIG. 5 is a schematic diagram of an example of a device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to ranking or otherwise classifying message posts in a community forum. For example, a community forum can correspond to a website or other document or application accessible by a client computer, which can display forum related content, such as posts authored by user accounts associated with the community forum or otherwise anonymous posts. The community forum can allow not only for creation of initial posts, but also for creation of response posts, which can be associated to the initial posts and additionally displayed on the community forum. Thus, the community forum can include a repository of initial posts and response posts for displaying upon request, and can also provide a platform for querying for posts (e.g., initial posts and/or response posts) within the repository based on matching search criteria to text or properties of the posts, etc.

In an example, response posts for a given initial post can be ranked based on probable relativity to the initial post, which can be determined based on one or more properties of the response post, such as general information of the response post, author information of the response post, message stylistic features of the response post, message semantical features of the response post, etc. For example, data from a data set of previous initial posts and corresponding response posts in the community forum can be used to create (e.g., train) a model to specify properties of a response post that may be indicative of an answer or information relevant to the initial post. Then, for a given received initial post and set of response posts, the response posts can be ranked or otherwise classified (e.g., as probably answers or non-answers to the initial post) based on the model. The ranked response posts can be displayed or otherwise provided from the community forum in ranked order so the most probable relevant answer is provided or displayed first.

In an example, the model can be trained by extracting features from response posts corresponding to a given initial post in the data set, where the features can correspond to the properties of the response post, along with an indication of whether the response post is an answer or non-answer and/or a value indicating probability that the response post is an answer or non-answer, etc. The model can determine values for the properties of answer and/or non-answer posts, and can determine a statistical significance of certain values of certain properties that may indicate a response post as an answer or otherwise relevant to the corresponding initial post. Then, for the given received initial post and response posts, similar features can be extracted and corresponding values compared to those of the model to determine whether one or more of the response posts include an answer or are otherwise relevant to the initial post, determine a relevancy score for the response post(s), etc., which can be used to rank or otherwise classify the response posts as answer/non-answer for displaying or providing the response posts in a corresponding order.

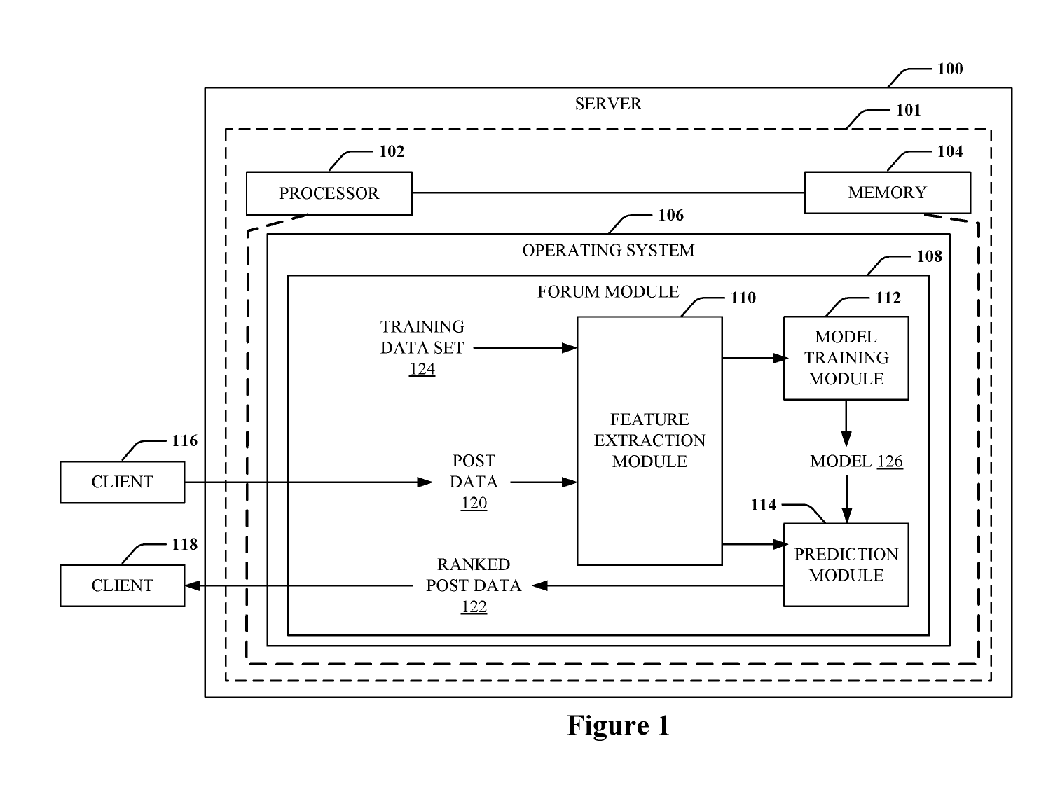

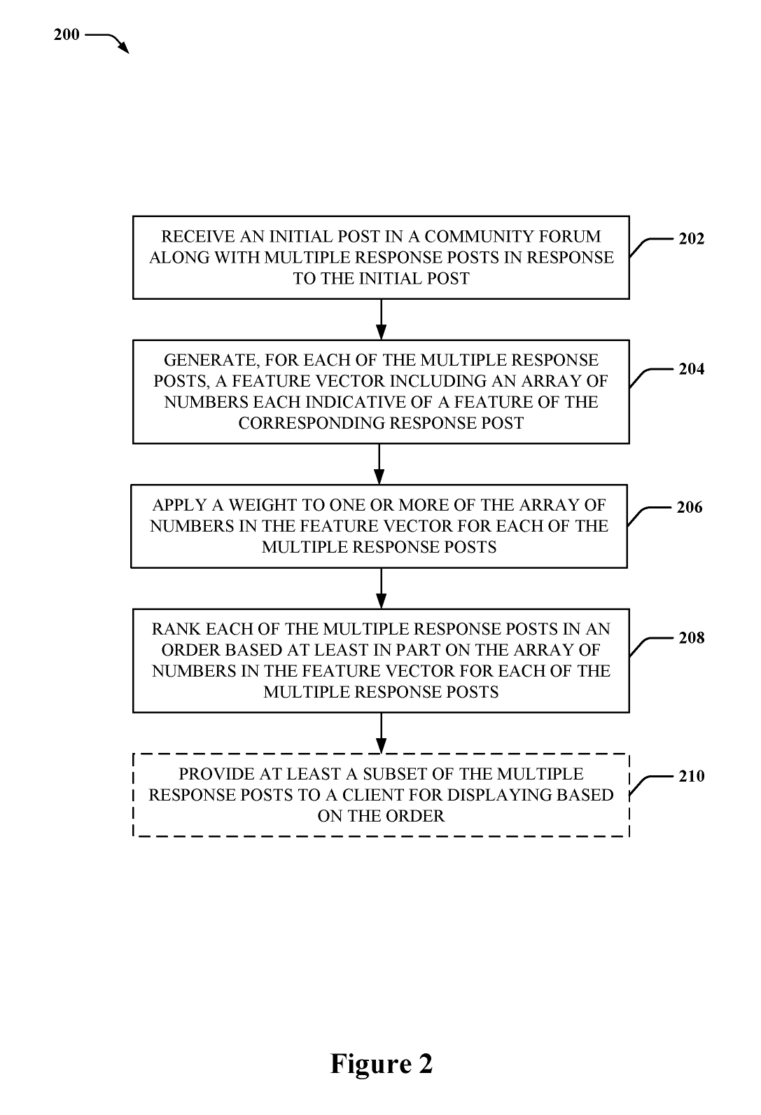

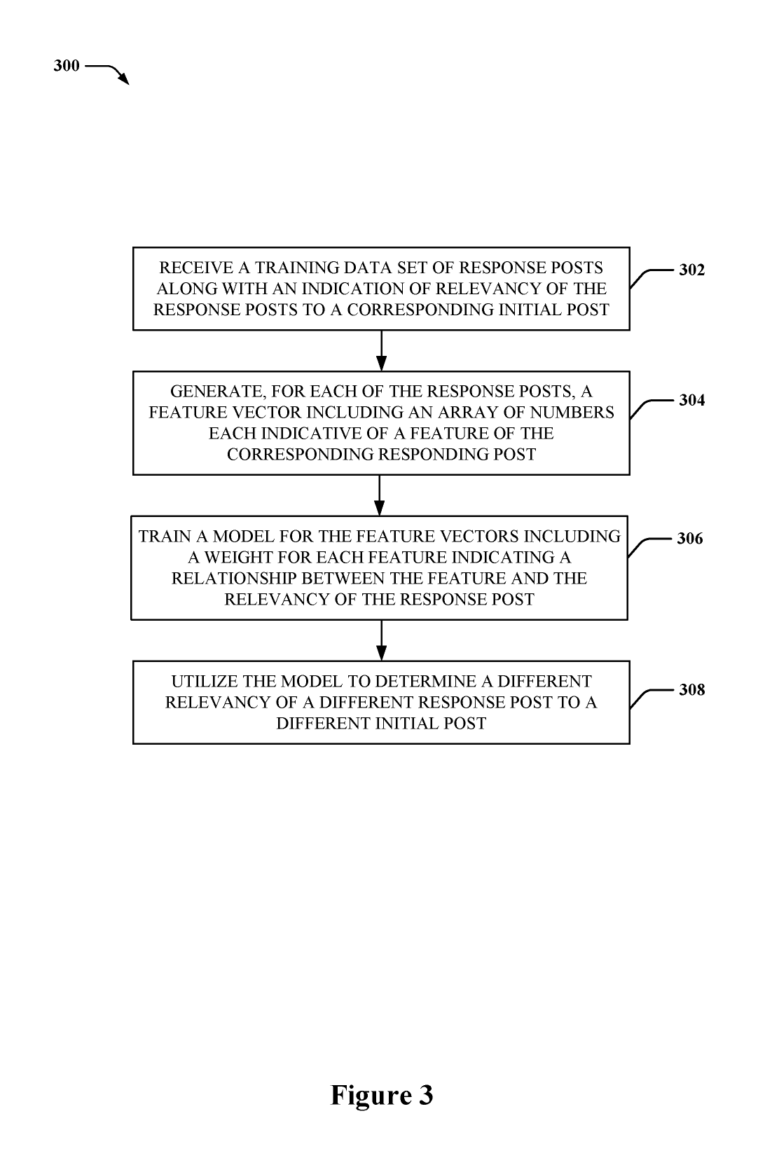

Turning now to FIGS. 1-5, examples are depicted with reference to one or more components and one or more methods that may perform the actions or operations described herein, where components and/or actions/operations in dashed line may be optional. Although the operations described below in FIGS. 2 and 3 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a server 100 (e.g., a computing device) that can provide a community forum functionality to allow various clients or other applications to view and/or contribute message posts to the forum. In an example, server 100 can include a processor 102 and/or memory 104 configured to execute or store instructions or other parameters related to providing an operating system 106, which can execute one or more applications, services, etc. The one or more applications, services, etc. may include a forum module 108 to provide the community forum functionality. For example, processor 102 and memory 104 may be separate components communicatively coupled by a bus (e.g., on a motherboard or other portion of a computing device, on an integrated circuit, such as a system on a chip (SoC), etc.), components integrated within one another (e.g., processor 102 can include the memory 104 as an on-board component 101), and/or the like. Memory 104 may store instructions, parameters, data structures, etc., for use/execution by processor 102 to perform functions described herein.

Forum module 108 can provide the community forum functionality including providing an interface (e.g., via a web server) to allow users to post (e.g., via managed user accounts, anonymously, etc.) messages (also referred to herein as “posts”), as well as an interface for allowing viewing of the posts (e.g., by other users via managed user accounts, anonymously, etc.). For example, forum module 108 can receive an initial post via the provided interface, which may be associated with a topic of the forum, one or more selectable sub-topics, etc., and may store the initial post in memory 104. Forum module 108 may then provide functionality (e.g., via one or more additional interfaces) for displaying the initial post, allowing response posts to be submitted in response to the initial post, querying a repository of posts to locate the initial post (and response posts), etc. The interfaces described herein may correspond to webpages accessible via a hypertext markup language (HTML) client application. In addition, the community forum provided by forum module 108 may have various functionalities often associated with community forums, such as user account management, alerting mechanisms to alert user accounts of new posts (response posts or otherwise), topic/sub-topic generation and display, voting mechanisms for relevancy of posts or expertise of user accounts authoring posts, spam detection, etc., which may not be fully described herein for ease of explanation.

Forum module 108, for example, may include components for ranking response posts submitted in responses to initial posts, which can be utilized in displaying ordered response results when viewing the posts. For example, forum module 108 may include a feather extraction module 110 for extracting features of one or more posts into a feature vector, a model training module 112 for training a model 126 of desirable response posts based on the features in the feature vectors of training data response posts, and/or a prediction module 114 for determining desirable response posts for a given initial post based on the model 126 trained or otherwise provided by the model training module 112. In one example, though shown as part of a single forum module 108 of a single server 100 in FIG. 1, one or more of the modules 110, 112, 114 may be part of another module of the server 100 and/or another server (not shown). For example, the model training module 112 may be on another server that obtains training data from forum module 108 on server 100, trains the model 126, and provides appropriate output back to the forum module 108 for use in prediction module 114.

In an example, a client 116 can include a client device or application that can access the forum module 108 of the server 100. For example, client 116 can include an HTML client that can access the forum module 108 via an internet connection, which may traverse multiple computer networks (not shown). The client 116, for example, can access an interface provided by the forum module 108 based on specifying a universal resource locator (URL) to the HTML client, which can resolve the URL to the server 100, and receiving the interface from the server 100 over a connection. The interface may allow the client 116 to specify post data 120 for storage in the forum module 108, where the post data 120 may include an initial post in the community forum, a response post to another initial post or response post authored by another user (or the same user) in the community forum, a vote for one or more response posts as related (or unrelated) to a corresponding initial post, a vote for expertise of an author of a response post, etc. Forum module 108 can at least store the post data 120 for subsequent retrieval for a request to view a corresponding initial post and/or response post.

In one example, given a training data set 124 of previously received posts (e.g., response posts and/or corresponding initial posts), which may include posts received by forum module 108 and stored in memory 104 or other posts received as a training data set 124 from other sources, forum module 108 can use the training data set 124 to train a model 126 for determining ranking of different (e.g., subsequently received) response posts. In an example, feature extraction module 110 can extract feature vectors from the training data set 124 along with indications of whether corresponding posts in the data set are answers to the initial post (and/or a rating of relevancy as an answer to the initial post). Model training module 112 can accordingly train a model 126 of the features to determine weights to be applied to the given features of a different post to determine whether the different post is likely an answer to a corresponding initial post (and/or a rating of relevancy as an answer to the initial post). Feature extraction module 110 can similarly additionally extract features from post data 120 received from client 116, and prediction module 114 can analyze the feature vector based on the model 126 to determine whether the post is an answer to an initial post (and/or a rating of relevancy as an answer to the initial post). Prediction module 114, for example, can accordingly rank response posts based on whether the posts are determined to be answers (and/or based on the rating of relevancy), and forum module 108 can display the response posts in the ranked order. In the depicted example, client 118 can receive the ranked post data 122 for display on another interface. In an example, client 118 can be the same client as client 116 and/or a different client requesting display of an initial post and corresponding response posts.

FIG. 2 is a flowchart of an example of a method 200 for ranking or otherwise classifying response posts to an initial post based on extracting features of the response posts. For example, method 200 can be performed by a server 100 and/or one or more components thereof to facilitate ranking and/or otherwise classifying the response posts.

In method 200, at action 202, an initial post can be received in a community forum along with multiple response posts in response to the initial post. In an example, forum module 108, e.g., in conjunction with processor 102, memory 104, operating system 106, etc., can receive the initial post in the community forum along with the multiple response posts in response to the initial post. For example, forum module 108 can receive the initial posts and corresponding response posts, at different times, as post data 120 from client 116 and/or additional clients operating different user accounts. For example, a client 116 can obtain the initial post from the forum module 108 for display, and can provide an interface to author a response post. The forum module 108 can also receive the response post and associate the response post with the initial post. The forum module 108 can receive multiple response posts (e.g., from multiple clients and/or associated user accounts) to associate with the initial post. For example, the initial post may include a question or other inquiry, a statement seeking advice on a matter, etc., and the response posts can include an answer or advice related to the initial post, or non-answer type of data (e.g., one-word posts, emoticons, another question, etc.). In an example, answer or advice type of response posts may have features that are not found, or not as prevalently found, in non-answer type of response posts. In an example, the initial post may also be a response post in a thread that can have associated sub-response posts, and need not necessarily be a top-level thread.

In this regard, in method 200, at action 204, a feature vector including an array of numbers each indicative of a feature of the corresponding response post can be generated for each of the multiple response posts. In an example, feature extraction module 110, e.g., in conjunction with processor 102, memory 104, operating system 106, forum module 108, etc., can generate, for each of the multiple response posts, the feature vector including the array of numbers each indicative of the feature of the corresponding response post. In an example, the numbers in the feature vector can correspond to an existence of the feature in the response post (e.g., a binary value), an occurrence level of the feature in the response post (e.g., a numeric value or range of possible values), etc. The feature extraction module 110 can detect the various features of the response post, and can accordingly populate the feature vector for the response post. For example, the features may include one or more indications related to general information of the response post, author information of the response post, message stylistic features of the response post, message semantical features of the response post, etc. In this regard, for example, feature extraction module 110 can convert raw textual data and metadata of the response posts (and/or initial post), as well as author information, into the array of numbers forming the feature vector.

In a specific example, the general information may include a length of text of the response post, a date posted, date modified, number of edits, votes received (e.g., as a solution or otherwise relevant to the initial post), forum information (e.g., name, topics, language, products, etc.), and/or the like. In another example, the author information may include a data the author joined the forum, a historical vote quality associated with the author, a historical answer rate of answers authored by the author, recognition or award points provided to the author, and/or the like. In another example, the message stylistic features may include counts of each HTML tag used in the text (e.g., styling, formatting, bullet points, images, links, etc.), count of special characters in the response post, counts of parts of speech used in text of the response post, percentage of usage of each part of speech in the text, number of punctuation marks, average length (e.g., in words) of sentences, number of misspellings, detected profanity, and/or the like.

In another example, message semantical features may include frequency distributions of n-grams and/or skip grams in the response post text (and/or the initial post text). For example, an n-gram can include a contiguous sequence of a number, n, of words from a given sequence of text. An n-gram, for example, can be one word, two words (e.g., “client application”), three words (e.g., “local area network’), etc. A skip gram (n, k) can include a sequence of n non-contiguous words with maximum distance between words in the text being k words. For example, a two word skip gram with 5 word skipping (a (2, 2) skip gram) may include “client using the application” where the two words are “client” and “application,” and there are no more than two other words (e.g., “using the”) in between. Leveraging skip grams along with n-grams can allow for overcoming potential data scarcity issues in the response text. In this example, the feature vector may include explicit n-grams and/or skip grams that are determined to be indicative of an answer response post (e.g., based on training data) and/or may include an indication or count of n-grams or skip grams that match between the response post and the corresponding initial post, etc., where a certain number and/or threshold may indicate the response post is more likely an answer.

In method 200, at action 206, a weight can be applied to one or more of the array of numbers in the feature vector for each of the multiple response posts. In an example, prediction module 114, e.g., in conjunction with processor 102, memory 104, operating system 106, forum module 108, etc., can apply the weight to the one or more of the array of numbers in the feature vector for each of the multiple response posts. For example, prediction module 114 can receive a model 126 from model training module 112, which can be generated based on training data as described further herein. The model 126 can indicate possible features of a response post that indicate the response post more likely includes an answer than does not. The indication can be in the form of weights for applying to each of the features in a feature vector, in one example. Thus, feature extraction module 110 can pass the feature vector generated from the response post(s) of the corresponding initial post to the prediction module 114 for determining which of the response posts more likely include an answer or other relevancy to the initial post. In an example, the response posts can be determined to include an answer, where the prediction module determines the weighted features add up to a threshold indicative of possible answer content in the response post. In another example, a relevancy score can be determined for the response post based on applying the weights to the features in the feature vector.

In method 200, at action 208, each of the multiple response posts can be ranked in an order based at least in part on the array of numbers in the feature vector for each of the multiple response posts. In an example, prediction module 114, e.g., in conjunction with processor 102, memory 104, operating system 106, forum module 108, etc., can rank each of the multiple response posts in the order based at least in part on the array of numbers in the feature vector for each of the multiple response posts. For example, prediction module 114 can rank the response posts based on whether or not the responses posts are determined to include an answer or other relevancy to the initial post (e.g., whether the weighted feature vector values for a given response post achieve a threshold). In another example, prediction module 114 can rank the response posts based on the corresponding relevancy score determined based on the weighted feature vector values. In an example, prediction module 114 can store an indication of the ranking in memory 104, which may include a ranking or order value associated with each of the response posts, an ordering of the response posts in memory based on the determined ranking or order, etc. In any case, ranking the multiple response posts may include ranking the posts based on a relevancy score, classifying the posts as an answer or non-answer, and/or the like.

In an example, the process of receiving the initial post, generating the feature vector, applying weights, and/or ranking the response posts can occur based on one or more of multiple possible detected conditions. For example, one or more of the actions 202, 204, 206, 208 can occur based on receiving a response post to the initial post (e.g., each time a response post is received and/or for a given response post when received to determine where to rank the response post among possible already received response posts). In another example, one or more of the actions 202, 204, 206, 208 can occur based on receiving (e.g., from client 118) a request for the initial post (e.g., for the message thread including the initial post and response posts). In another example, the one or more of the actions 202, 204, 206, 208 can occur based on a request to rank the response posts (e.g., from a client application/user account, from another component of the forum module 108, and/or the like). Still, in another example, the one or more of the actions 202, 204, 206, 208 can occur based on receiving an updated model 126 from the model training module 112 (e.g., which can update the module based on one or more of the above detected conditions). In any case, the forum module 108 can detect response posts with potential answers based on knowledge of the document structure, as discerned from the model 126, author ranking, etc., and can accordingly rank or otherwise classify the response posts.

In method 200, optionally at action 210, at least a subset of the multiple response posts can be provided to a client for displaying based on the order. In an example, forum module 108, e.g., in conjunction with processor 102, memory 104, operating system 106, etc., can provide at least the subset of the multiple response posts to the client for displaying based on the order. For example, forum module 108 can provide the response posts to client 118 (e.g., an HTML client) for display on a client device. Forum module 108, in this example, can provide the response posts with an indicated ordering based on the ranking, and client 118 can accordingly display the response posts based on the ranking. As described, in an example, the client 118 may also provide, via instructions from forum module 108, a mechanism for voting for response post relevancy to the initial post, voting for author expertise, etc., which can, in one example, be provided to the model training module 112 for further (e.g., real-time or near real-time) training of the model 126. Thus, in this example, the feature vector for a voted response post can be provided to the model training module 112 along with voting information to associate the features of the response post with an indication of whether the response post includes an answer and/or relevancy to the initial post.

FIG. 3 is a flowchart of an example of a method 300 for training a model for feature vectors of response posts in determining whether response posts likely include answers or other relevancy to an initial post. For example, method 300 can be performed by a server 100 and/or one or more components thereof to facilitate generating the model.

In method 300, at action 302, a training data set of response posts can be received along with an indication of relevancy of the response posts to a corresponding initial post. In an example, forum module 108, e.g., in conjunction with processor 102, memory 104, operating system 106, etc., can receive the training data set 124 of the response posts along with the indication of relevancy of the response posts to the corresponding initial post. For example, forum module 108 can receive the training data set 124 as prior posts stored by forum module 108 and/or as other training data from other forums. In one example, as described, the model 126 can be created by another server and/or based on other forum data, and provided to forum module 108 for use in predicting answer and/or relevancy of response posts to initial posts. In another example, each time a response post is provided and/or a vote for a response post as including an answer or not is provided, forum module 108 can determine the response post, associated feature vector information, etc., and can include the response post in the model (e.g., for real-time and/or near real-time updating of the model).

In method 300, at action 304, for each of the responses posts, a feature vector including an array of numbers each indicative of a feature of the corresponding response post can be generated. In an example, feature extraction module 110, e.g., in conjunction with processor 102, memory 104, operating system 106, forum module 108, etc., can generate, for each of the response posts, a feature vector including an array of numbers each indicative of the feature of the corresponding response post. As described, feature extraction module 110 can extract the features as general information of the response post, author information of the response post, message stylistic features of the response post, message semantical features of the response post, etc. Moreover, as described, feature extraction module 110 can populate the feature vector with numbers related to the given features, such as a bit indicating an existence of a feature in the response post, a number indicating a number of instances of the feature in the response post, etc.

In method 300, at action 306, a model for the feature vectors can be trained including a weight for each feature indicating a relationship between the feature and the relevancy of the response post. In an example, model training module 112, e.g., in conjunction with processor 102, memory 104, operating system 106, forum module 108, etc., can train the model 126 for the feature vectors including the weight for each feature indicating the relationship between the feature and the relevancy of the response post. In an example, the relevancy may relate to whether the response post includes an answer to the corresponding initial post, which may be indicated based on an explicit indication (e.g., an output label specified for the response post by forum module 108 by a creator for the training data set 124, specified by an author of the post, etc.), voting by users of the forum related to the training data set 124, etc., and may include an indication of answer or non-answer, a relevancy score (e.g., based on a number of votes for the response post), etc.

In any case, for example, model training module 112 can determine common or similar features among posts that have a threshold relevancy to the initial post (e.g., and/or are indicated as answers to the initial post), and can determine weights for these features (e.g., as being more highly weighted than features that are as common among post that have the threshold relevancy to the initial post). In an example, model training module 112 can utilize a machine-learning mechanism to train the model 126, and the training process can programmatically associate the weight with the individual feature components of the feature vector to maximum the discriminative power between categories of the output labels. In one example, model training module 112 can include a predictor using the Naïve Bayes model. In an example, where “x”=(x1, x2, . . . xn) is the feature vector including n features extracted from the feature extraction process, the model can assign a probability p(Ck|“x”) to each possible output of the model. C1 can represent the class of answer response posts, where C0 represents the class of non-answer response posts. Using Bayes theorem, these probabilities can be estimated based on the following:

p(Ck|“x”)=(p(Ck)p(“x”|Ck))/(p(“x”))

Or, in other words, “posterior”=(“prior”×“likelihood”)/“evidence.” In an example, an optimal decision of classification for a given response post can be equivalent to choosing the class Ck that maximizes the corresponding probability p(Ck). The confidence score following that decision can rely on the value of the probability measure p(Ck) itself.

In method 300, at action 308, the model can be utilized to determine a different relevancy of a different response post to a different initial post. In an example, prediction module 114, e.g., in conjunction with processor 102, memory 104, operating system 106, forum module 108, etc., can utilize the model 126 to determine the different relevancy of the different response post to the different initial post. In an example, prediction module 114 can apply weights generated in the trained model 126 to a feature vector of the different response to determine whether the different response post includes an answer or other relevancy to the initial post, which may include determining whether one or more weighted values in the feature vector achieve one or more thresholds, as described above.

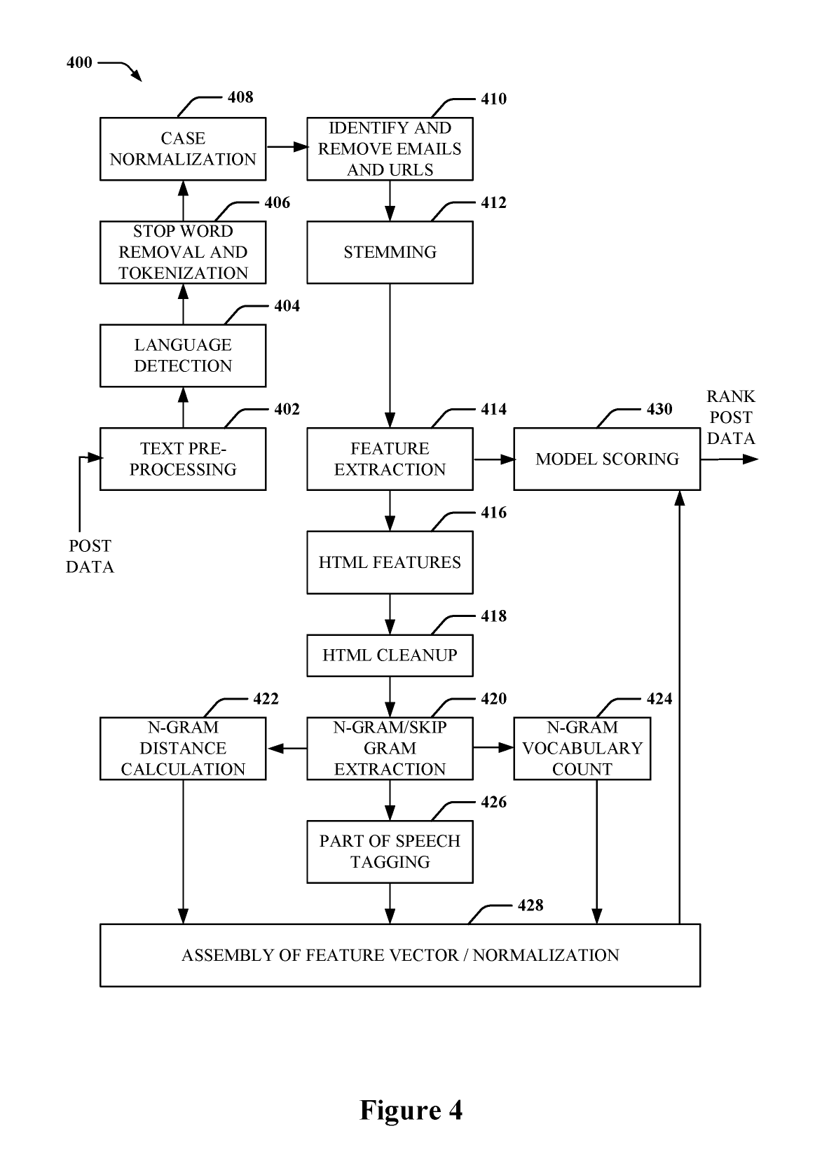

FIG. 4 illustrates an example of a data flow 400, which can be performed by forum module 108, feature extraction module 110, model training module 112, etc., for extracting and/or scoring feature vectors from post data. As described, post data of an initial post and/or one or more response posts, which can be part of data from a forum module 108, a training data set, etc., can be received. For example, the post data may include a title, which can be set be the initial post, the initial post (which may include a question), and a plurality of response posts (which may or may not include answers to the question). The post data, for example, may include text data received from one or more clients via forum module 108 or other forum modules. The post data can be provided to a text pre-preprocessing action 402, which can format the text for further processing, such as by separating the post text for each post from other details of the post. The resulting data can be provided to a language detection action 404 for detecting a language associated with the post, e.g., English, Spanish, French, etc., such to facilitate language specific actions to be performed on the post data. The resulting data can be provided to a stop word removal and tokenization action 406 for performing stop word removal and/or tokenization, which may include removing highly frequent words that carry no information from the resulting data, such as “the,” “a,” “an,” “this,” “that,” etc., breaking down a given sentence string in the resulting data into individual word tokens, and/or the like. The resulting data can be provided to a case normalization action 408 for applying a same casing to the text so all letters are case-agnostic (e.g., all lower case or otherwise), which can simplify feature detection. In addition, for example, the resulting data can be provided to an identify and remove emails and URLs action 410 for removal of email addresses and URLs (and/or other links that may not be indicative of response text). The resulting data can be provided to a stemming action 412 for performing stemming on the resulting data, which may include normalizing words of different inflections into the same root, such as plural forms into singular forms, past tense into present tense, etc., which may allow for increasing word overlapping between documents for measuring similarity.

A feature extraction action 414 can be performed on the resulting data to determine one or more features associated with at least the response post text of each response post, as described above. For example, this can include extracting general information of a given response post, author information of the response post, message stylistic features of the response post, message semantical features of the response post, etc. This feature extraction action 414 may include extracting features such as a length of text of the response post, a date posted, date modified, number of edits, votes received (e.g., as a solution or otherwise relevant to the initial post), forum information (e.g., name, topics, language, products, etc.), a data the author joined the forum, a historical vote quality associated with the author, a historical answer rate of answers authored by the author, recognition or award points provided to the author, count of special characters in the response post, number of punctuation marks, average length (e.g., in words) of sentences, number of misspellings, detected profanity, etc. In one example, one or more features may relate to the existence of one or more types of tags, a number of one or more types of tags, etc., which can be identified in the response post text, and the corresponding feature vector can be appropriately set/updated.

The resulting data can be provided to an HTML cleanup action 418 for removal of the HTML tags and/or other HTML-specific text in the post data. The resulting data can provided to an n-gram/skip gram extraction action 420 for determining one or more n-grams or skip grams in the response post text for each of the response posts. For example, this can include searching for certain defined n-grams and/or skip grams (which may include n-grams and/or skip grams extracted from the training data set), n-grams and/or skip grams extracted from the corresponding initial post, etc. The detected n-grams and/or skip grams can be provided to an n-gram distance calculation action 422 for computing a distance (e.g., in words) between n-grams in the response text and/or an n-gram vocabulary count action 424 for counting the number of (e.g., frequency distribution of) extracted n-grams that match a defined vocabulary. For example, the vocabulary can correspond to n-grams detected in the training data set or can otherwise be specified. The resulting data can also be provided to a part of speech tagging action 426 for counting parts of speech used in the response post text (e.g., nouns, verbs, adjectives, adverbs, etc.), determining a percentage of usage of each part of speech in the text, etc. The resulting data can be provided to an assembly of feature vector and/or normalization thereof action 428 to generate the feature vector as a vector of numbers each indicative of a feature in the response post text.

The feature vector can be provided to a model scoring action 430, which can apply weights to the features of the feature vector based on a trained model, as described. The features, with weights applied, can be analyzed to determine whether a given response post purportedly includes an answer (e.g., based on whether a sum of the weighted features achieves a threshold, based on scores of individual features, etc.), and/or can be analyzed to determine a relevancy score for a given response post. The response posts can then be ranked, as described, based on whether the response post is determined to include an answer, the relevancy score for the response posts, etc.

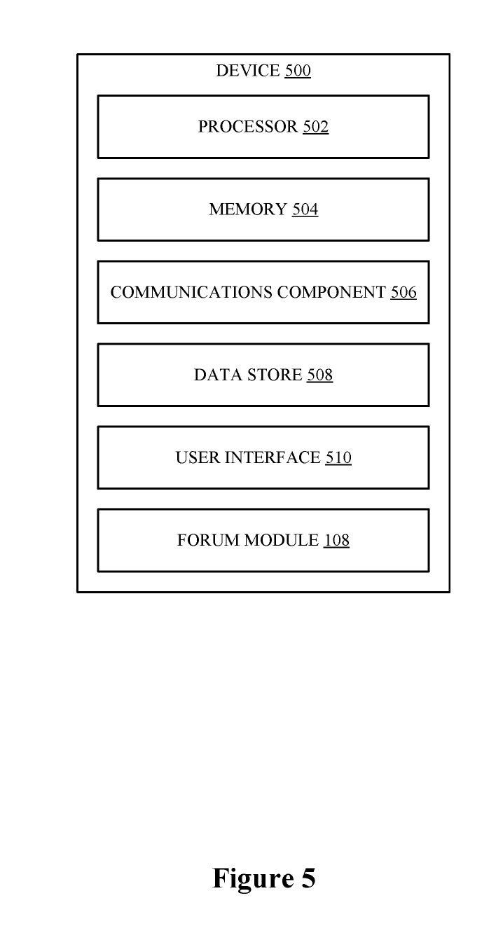

FIG. 5 illustrates an example of device 500, similar to or the same as server 100, client 116/118, etc. (FIG. 1), including additional optional component details as those shown in FIG. 1. In one implementation, device 500 may include processor 502, which may be similar to processor 102 for carrying out processing functions associated with one or more of components and functions described herein. Processor 502 can include a single or multiple set of processors or multi-core processors. Moreover, processor 502 can be implemented as an integrated processing system and/or a distributed processing system.

Device 500 may further include memory 504, which may be similar to memory 104 such as for storing local versions of applications being executed by processor 502, such as forum module 108, applications, related instructions, parameters, etc. Memory 504 can include a type of memory usable by a computer, such as random access memory (RAM), read only memory (ROM), tapes, magnetic discs, optical discs, volatile memory, non-volatile memory, and any combination thereof.

Further, device 500 may include a communications component 506 that provides for establishing and maintaining communications with one or more other devices, parties, entities, etc., utilizing hardware, software, and services as described herein. Communications component 506 may carry communications between components on device 500, as well as between device 500 and external devices, such as devices located across a communications network and/or devices serially or locally connected to device 500. For example, communications component 506 may include one or more buses, and may further include transmit chain components and receive chain components associated with a wireless or wired transmitter and receiver, respectively, operable for interfacing with external devices.

Additionally, device 500 may include a data store 508, which can be any suitable combination of hardware and/or software, that provides for mass storage of information, databases, and programs employed in connection with implementations described herein. For example, data store 508 may be or may include a data repository for applications and/or related parameters (e.g., forum module 108, applications, etc.) not currently being executed by processor 502. In addition, data store 508 may be a data repository for forum module 108, applications, and/or one or more other components of the device 500.

Device 500 may include a user interface component 510 operable to receive inputs from a user of device 500 and further operable to generate outputs for presentation to the user. User interface component 510 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

Device 500 may additionally include forum module 108, as described, for providing a community forum and related functionality for extracting features of forum posts, ranking response posts for corresponding initial posts, building models for determining rankings for the response posts, etc.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more implementations, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various implementations described herein. Various modifications to these implementations will be readily apparent to those skilled in the art, and the generic principles defined herein may be applied to other implementations. Thus, the claims are not intended to be limited to the implementations shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various implementations described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for classifying responses to a post in a community forum, comprising:
receiving an initial post in the community forum along with multiple response posts in response to the initial post;
generating, for each of the multiple response posts, a feature vector comprising an array of numbers each indicative of a feature of the corresponding response post;
applying a weight to one or more of the array of numbers in the feature vector for each of the multiple response posts;
ranking each of the multiple response posts in an order based at least in part on the array of numbers in the feature vector for each of the multiple response posts; and
providing at least a subset of the multiple response posts to a client for displaying based on the order.

2. The method of claim 1, wherein ranking each of the multiple response posts comprises classifying each of the multiple response posts as including an answer to the initial post or not including an answer to the initial post based at least in part on comparing one or more of the array of numbers to one or more thresholds.

3. The method of claim 1, wherein features corresponding to the array of numbers include author information of a given response post, message stylistic features of the given response post, and message semantical features of the given response post.

4. The method of claim 3, wherein the message stylistic features includes at least one of a number of hypertext markup language (HTML) tags, a number of special characters, a number of parts of speech, a percentage of usage of each of the number of parts of speech, an average word length of one or more sentences, a number of misspellings, and/or profanity detection.

5. The method of claim 3, wherein the message semantical features include a frequency distribution of at least one of a number of skip grams or a number of n-grams in the given response post.

6. The method of claim 1, further comprising determining the weight for the one or more of the array of numbers based at least in part on a model, wherein the model associates features corresponding to the one or more of the array of numbers to training data response posts indicated as including an answer to a training data initial post.

7. The method of claim 6, further comprising:
receiving a training data set of the training data response posts along with an indication of relevancy of the training data response posts to the training data initial post;
generating, for each of the training data response posts, a training data feature vector; and
training the model based on the training data feature vectors for each of the training data response posts and the indication of relevancy of each of the training data response posts,
wherein determining the weight is based at least in part on determining, from the model, which features of the training data feature vectors correspond to a certain indication of the relevancy of the training data response posts.

8. A device for classifying responses to a post in a community forum, comprising:
a memory storing one or more parameters or instructions for providing the community forum; and
at least one processor coupled to the memory, wherein the at least one processor is configured to:
receive an initial post in the community forum along with multiple response posts in response to the initial post;
generate, for each of the multiple response posts, a feature vector comprising an array of numbers each indicative of a feature of the corresponding response post;
apply a weight to one or more of the array of numbers in the feature vector for each of the multiple response posts;
rank each of the multiple response posts in an order based at least in part on the array of numbers in the feature vector for each of the multiple response posts; and
provide at least a subset of the multiple response posts to a client for displaying based on the order.

9. The device of claim 8, wherein the at least one processor is configured to rank each of the multiple response posts at least in part by classifying each of the multiple response posts as including an answer to the initial post or not including an answer to the initial post based at least in part on comparing one or more of the array of numbers to one or more thresholds.

10. The device of claim 8, wherein features corresponding to the array of numbers include author information of a given response post, message stylistic features of the given response post, and message semantical features of the given response post.

11. The device of claim 10, wherein the message stylistic features includes at least one of a number of hypertext markup language (HTML) tags, a number of special characters, a number of parts of speech, a percentage of usage of each of the number of parts of speech, an average word length of one or more sentences, a number of misspellings, and/or profanity detection.

12. The device of claim 10, wherein the message semantical features include a frequency distribution of at least one of a number of skip grams or a number of n-grams in the given response post.

13. The device of claim 8, wherein the at least one processor is further configured to determine the weight for the one or more of the array of numbers based at least in part on a model, wherein the model associates features corresponding to the one or more of the array of numbers to training data response posts indicated as including an answer to a training data initial post.

14. The device of claim 13, wherein the at least one processor is further configured to:
receive a training data set of the training data response posts along with an indication of relevancy of the training data response posts to the training data initial post;
generate, for each of the training data response posts, a training data feature vector; and
train the model based on the training data feature vectors for each of the training data response posts and the indication of relevancy of each of the training data response posts,
wherein the at least one processor is configured to determine the weight based at least in part on determining, from the model, which features of the training data feature vectors correspond to a certain indication of the relevancy of the training data response posts.

15. A computer-readable medium, comprising code executable by one or more processors for classifying responses to a post in a community forum, the code comprising code for:
receiving an initial post in the community forum along with multiple response posts in response to the initial post;
generating, for each of the multiple response posts, a feature vector comprising an array of numbers each indicative of a feature of the corresponding response post;
applying a weight to one or more of the array of numbers in the feature vector for each of the multiple response posts;
ranking each of the multiple response posts in an order based at least in part on the array of numbers in the feature vector for each of the multiple response posts; and
providing at least a subset of the multiple response posts to a client for displaying based on the order.

16. The computer-readable medium of claim 15, wherein the code for ranking each of the multiple response posts classifies each of the multiple response posts as including an answer to the initial post or not including an answer to the initial post based at least in part on comparing one or more of the array of numbers to one or more thresholds.

17. The computer-readable medium of claim 15, wherein features corresponding to the array of numbers include author information of a given response post, message stylistic features of the given response post, and message semantical features of the given response post.

18. The computer-readable medium of claim 17, wherein the message stylistic features includes at least one of a number of hypertext markup language (HTML) tags, a number of special characters, a number of parts of speech, a percentage of usage of each of the number of parts of speech, an average word length of one or more sentences, a number of misspellings, and/or profanity detection.

19. The computer-readable medium of claim 17, wherein the message semantical features include a frequency distribution of at least one of a number of skip grams or a number of n-grams in the given response post.

20. The computer-readable medium of claim 15, further comprising code for determining the weight for the one or more of the array of numbers based at least in part on a model, wherein the model associates features corresponding to the one or more of the array of numbers to training data response posts indicated as including an answer to a training data initial post.
